(19) United States
(12) Patent Application Publication
(10) Pub. No.: US 2015/0000768 A1
(43) Pub. Date: Jan. 1, 2015

(54) REFRIGERATION SYSTEM AND BALL VALVE THEREOF

(71) Applicant: Zhejiang Sanhua Co., Ltd., Xinchang Country, Zhejiang Province (CN)

(72) Inventor: Xufeng Zheng, Xinchang County (CN)

(21) Appl. No.: 14/376,888

(22) PCT Filed: Dec. 31, 2012
(86) PCT No.: PCT/CN2012/088013

§ 371 Date: Aug. 6, 2014

(30) Foreign Application Priority Data
Feb. 21, 2012 (CN) 201210039944.0

(51) Int. Cl. F25B 41/04; F16K 17/04; F16K 15/18; F16K 5/06; F16K 15/06

(52) U.S. Cl. CPC F25B 41/04; F16K 5/0605; F16K 5/0689; F16K 15/06; F16K 15/188; F16K 17/04
USPC 137/511

(57) ABSTRACT

A ball valve includes a valve body, the valve body has a valve cavity, a first connecting port and a second connecting port; a valve rod and a valve ball are provided inside the valve cavity, the valve ball is provided with a valve ball passage, the valve rod is configured to drive the valve ball to rotate to allow or disconnect a communication between the first connecting port and the second connecting port via the valve ball passage; wherein, a one-way valve having a preset opening pressure is provided between the valve ball passage and the first connecting port, and in a case that the valve ball disconnects the communication between the first connecting port and the second connecting port, the one-way valve is configured to allow a one-way communication from the valve ball passage to the first connecting port.

This application claims the benefit of priority to Chinese Patent Application No. 201210039944.0 titled “REFRIGERATION SYSTEM AND BALL VALVE THEREOF”, filed with the Chinese State Intellectual Property Office on Feb. 21, 2012, the entire disclosure of which is incorporated herein by reference.

### TECHNICAL FIELD

The present application relates to the technical field of refrigerant fluid control components, and particularly to a ball valve. Moreover the present application further relates to a refrigerating system having the ball valve.

### BACKGROUND

A ball valve is widely used in a refrigerating system as a valve switch element for allowing or preventing the flow of refrigerant. Reference is made to FIGS. 1 and 2, FIG. 1 is a schematic view showing the structure of a ball valve in the conventional technology; and FIG. 2 is a schematic structural view showing the cooperation between a positioning pin and a valve rod of the ball valve in FIG. 1.

As shown in FIG. 1, the conventional ball valve is used in a refrigerating system including an indoor unit and an outdoor unit. The ball valve includes a valve body, and the valve body has a valve cavity 1′1, a first connecting port 2′1 connected to the outdoor unit and a second connecting port 1′2 connected to the indoor unit. A valve ball 3′ and a valve rod 4′ are provided inside the valve cavity 1′1, the valve ball 3′ is provided with a valve ball passage 3′1, and the valve rod 4′ may drive the valve ball 3′ to rotate so as to allow or prevent the communication between the first connecting port 2′1 and the second connecting port 1′2 via the valve ball passage 3′1.

As shown in FIG. 1, the valve body includes a valve main body 1′ and a valve seat 2′which cooperate with each other to form the valve cavity 1′1. The first connecting port 2′1 is arranged on the valve seat 2′, and the second connecting port 1′2 is arranged on the valve main body 1′. A first sealing member 6′1 for isolating the first connecting port 2′1 from the valve cavity 1′1 is provided between the valve seat 2′ and one side of the valve ball 3′, and a second sealing member 6′2 for isolating the second connecting port 1′2 from the valve cavity 1′1 is provided between the valve main body 1′ and another side of the valve ball 3′. As shown in FIG. 2, the valve main body 1′ is provided with two positioning bosses 1′3, and the two positioning bosses 1′3 and a positioning pin 5′ are cooperated with each other to form a limit for the fully open position of the ball valve. In the above structure, a sealing surface of each of the first sealing member 6′1 and the second sealing member 6′2 is a spherical surface having a curvature radius same as a curvature radius of the valve ball 3′, and the valve seat 2′ is screwed onto the valve main body 1′ through a certain torque, thus the first sealing member 6′1 and the second sealing member 6′2 are compressed so as to abut against the spherical surface of the valve ball 3′, thereby realizing the sealing.

In the above structure, when the first connecting port 2′1 of the ball valve is connected to the outdoor unit and is filled with refrigerant, the valve ball 3′ will be pushed out of the valve seat due to the pressure of the refrigerant, thus the first sealing member 6′1 is disengaged from the valve ball 3′, and the refrigerant flows into the valve cavity 1′1 through a clearance between the first sealing member 6′1 and the valve ball 3′, however, since the second sealing member 6′2 at this time is still in a sealing state at the side of the valve main body 1′, the refrigerant cannot be discharged via this side of the valve main body 1′, thus is remained inside the valve cavity 1′1. When the second connecting port 2′1 of the ball valve is welded to the indoor unit, since there is no cooling protection during the welding process, the pressure of the refrigerant inside the valve cavity 1′1 is increased as the temperature rises, but the refrigerant cannot be discharged, therefore causing a potential safety hazard.

Recently, in the conventional technology, a small hole is provided in the spherical wall of the valve ball 3′ to avoid an overly high pressure inside the valve cavity 1′1 and eliminate the potential safety hazard, and the small hole is arranged at a side of the valve ball 3′ close to the valve seat 2′ so as to relieve the high pressure inside the valve cavity 1′1, thereby eliminating the potential safety hazard. However, after the second connecting port 1′2 is welded to the indoor unit, a pressurized leak detection is required to be performed at the side of the indoor unit, and at this time, the valve ball 3′ will be pushed out of the valve main body 1′, thus the second sealing member 6′2 is disengaged from the valve ball 3′at the side of the valve main body 1′, and air inside the indoor unit may flow into the valve cavity 1′1 via the clearance, and the air may further flow into the outdoor unit via the pressure relief hole to be mixed with the refrigerant, therefore the refrigerating and heating functions of the system are adversely affected.

### SUMMARY

One technical problem to be solved by the present application is to provide a ball valve, and the structural design of the ball valve may, on one hand, avoid an overly high pressure inside a valve cavity when the ball valve is welded to an indoor unit, thereby eliminating the potential safety hazard; and on the other hand, prevent air inside the indoor unit from flowing into the first connecting port to be mixed with the refrigerant inside an outdoor unit when a pressurized leak detection is performed, thereby ensuring the refrigerating performance. Furthermore, another technical problem to be solved by the present application is to provide a refrigerating system including the ball valve.

To solve the above technical problems, a ball valve according to the present application includes a valve body, the valve body has a valve cavity, a first connecting port and a second connecting port; a valve rod and a valve ball are provided inside the valve cavity, the valve ball is provided with a valve ball passage, the valve rod is configured to drive the valve ball to rotate to allow or disconnect a communication between the first connecting port and the second connecting port via the valve ball passage; wherein, a one-way valve having a preset opening pressure is provided between the valve ball passage and the first connecting port, and in a case that the valve ball disconnects the communication between the first connecting port and the second connecting port, the one-way valve is configured to allow a one-way communication from the valve ball passage to the first connecting port.

Preferably, the one-way valve is provided on a spherical wall of the valve ball.

Preferably, the spherical wall of the valve ball is provided with a mounting hole for mounting the one-way valve, an inner side of the mounting hole is provided with a valve port in communication with the valve ball passage, and the one-way valve is configured to open or close the valve port.

Preferably, the one-way valve includes a seat provided inside the mounting hole, a guiding rod movable with respect to the seat, a restoring component provided between the seat and the guiding rod, and a valve plug connected to the guiding rod and configured to open or close the valve port.

Preferably, the seat includes a seat main body having an outer diameter smaller than an inner diameter of the mounting hole, the seat main body is provided with a plurality of supporting ribs supported on an inner wall of the mounting hole in a circumferential direction, and a seat passage configured to communicate the mounting hole with the first connecting port is formed by a clearance between adjacent supporting ribs.

Preferably, the seat main body is provided with a guiding hole, and the guiding rod has one end slidably provided in the guiding hole and another end provided with a mounting portion for mounting the valve plug; and the restoring component is arranged outside circumferential outer portions of the seat main body and the guiding rod, and is supported between the supporting ribs and the mounting portion.

Preferably, the mounting portion is provided with a mounting groove, and the valve plug is mounted in the mounting groove in an interference fit or by riveting.

Preferably, an inner wall of the mounting hole is provided with an annular groove at a side close to the first connecting port, and the annular groove is provided with a retaining ring for supporting the seat.

Preferably, the valve body includes a valve main body and a valve seat, the valve seat and the valve main body cooperate with each other to form the valve cavity, the first connecting port is provided on the valve seat, and the second connecting port is provided on the valve main body; and

a first sealing member for isolating the first connecting port from the valve cavity is provided between the valve seat and one side of the valve ball, and a second sealing member for isolating the second connecting port from the valve cavity is provided between the valve main body and another side of the valve ball.

Furthermore, to solve the above technical problems, a refrigerating system is further provided according to the present application, which includes an indoor unit and an outdoor unit; the refrigerating system further includes a ball valve according to any one of the above solutions, and the first connecting port is connected to the outdoor unit, and the second connecting port is connected to the indoor unit.

Based on the conventional technology, in the ball valve according to the present application, the one-way valve having a preset opening pressure is provided between the valve ball passage and the first connecting port, and when the valve ball disconnects the communication between the first connecting port and the second connecting port, the one-way valve may allow a one-way communication from the valve ball passage to the first connecting port. The first connecting port may be connected to an outdoor unit of the refrigerating system, and the second connecting port may be connected to an indoor unit of the refrigerating system.

When the first connecting port of the ball valve is connected to the outdoor unit and is filled with refrigerant, the valve ball will be pushed out of the valve seat due to the pressure of the refrigerant, thus the first sealing member is disengaged from the valve ball, and the refrigerant flows into the valve cavity via a clearance between the first sealing member and the valve ball, however, since the second sealing member at this time is still in a sealing state at the side of the valve main body, the refrigerant cannot be discharged via this side of the valve main body, thus is remained inside the valve cavity. When the pressure inside the valve cavity is balanced with the pressure inside a pipe at the side of the outdoor unit, the first sealing member functions again, and the valve cavity at this time is a sealed cavity. When the second connecting port of the ball valve is welded to the indoor unit, since the valve cavity has a constant volume, the pressure inside the valve cavity increases as the temperature rises according to the expression of PV/T=constant. When a pressure difference between the pressure inside the valve cavity and a pressure at the side of the first connecting port reaches a preset opening pressure (for example, 5 MPa), the one-way valve is opened to relieve the pressure of the valve cavity, and finally the pressure inside the valve cavity and the pressure at the side of the first connecting port are balanced, thereby eliminating the potential safety hazard.

When the side of the indoor unit is inflated to perform a pressurized leak detection, the valve ball will be pushed out of the side of the valve main body, thus the second sealing member at the side of the valve main body is disengaged from the valve ball, and air inside the indoor unit flows into the valve cavity via a clearance. Since the inflation pressure is generally small (for example, 4 MPa), which is smaller than the preset opening pressure, and the side of the outdoor unit is already filled with refrigerant at this time, a pressure difference between the valve cavity and the side of the outdoor unit is definitely smaller than the preset opening pressure, thus the one-way valve will not be opened, which also prevents the air inside the indoor unit from being mixed with the refrigerant inside the outdoor unit, thereby ensuring the refrigerating and heating performances of the system.

In summary, the structural design of the ball valve according to the present application may, on one hand, avoid an overly high pressure inside a valve cavity when the ball valve is welded to an indoor unit, thereby eliminating the potential safety hazard; and on the other hand, prevent air inside the indoor unit from flowing into the first connecting port to be mixed with the refrigerant inside an outdoor unit when a pressurized leak detection is performed, thereby ensuring the refrigerating performance.

Furthermore, in the present application, the refrigerating system having the ball valve has identical effects as the ball valve, which will not be described herein.

### BRIEF DESCRIPTION OF THE DRAWINGS

FIG. 1 is a schematic view showing the structure of a ball valve in the conventional technology;

FIG. 2 is a schematic structural view showing the cooperation between a positioning pin and a valve rod of the ball valve in FIG. 1;

FIG. 3 is a schematic view showing the structure of a ball valve according to an embodiment of the present application;

FIG. 4 is a partially enlarged view of portion A of the ball valve in FIG. 3; and

FIG. 5 is a schematic view showing the structure of a seat of the ball valve in FIGS. 3 and 4.

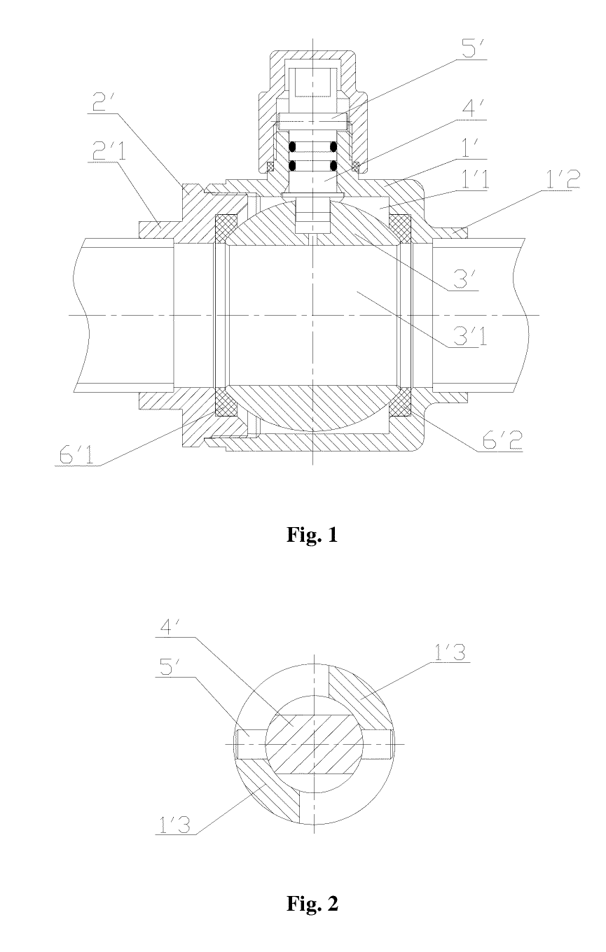

Corresponding relationships between reference numerals and components in FIGS. 1 and 2 are as follows:

| | | | |
|---|---|---|---|
| 1′ | valve main body, | 1′1 | valve cavity, |
| 1′2 | second connecting port, | 1′3 | positioning boss; |
| 2′ | valve seat, | 2′1 | first connecting port; |
| 3′ | valve ball, | 3′1 | valve ball passage; |
| 4′ | valve rod; | 5′ | positioning pin; |
| 6′1 | first sealing member; and | 6′2 | second sealing member. |

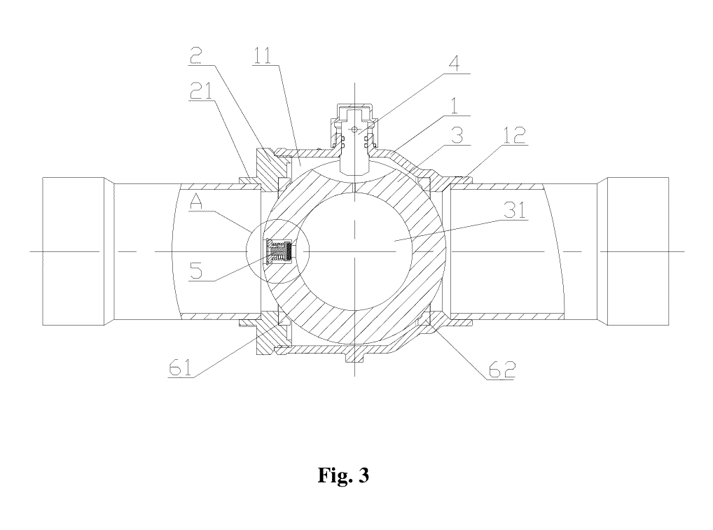

Corresponding relationships between reference numerals and components in FIGS. 3 to 5 are as follows:

| | | | |
|---|---|---|---|
| 1 | valve main body, | 11 | valve cavity, |
| 12 | second connecting port; | 2 | valve seat, |
| 21 | first connecting port; | 3 | valve ball, |
| 31 | valve ball passage; | 32 | mounting hole, |
| 321 | annular groove; | 33 | valve port; |
| 4 | valve rod; | 5 | one-way valve; |
| 51 | seat, | 511 | seat passage, |
| 512 | seat main body, | 513 | supporting rib, |
| 514 | guiding hole; | 52 | guiding rod; |
| 521 | mounting portion; | 521a | mounting groove; |
| 53 | restoring component; | 54 | valve plug, |
| 55 | retaining ring; | 61 | first sealing member; and |
| 62 | second sealing member. | | |

### DETAILED DESCRIPTION

An object of the present application is to provide a ball valve, and the structural design of the ball valve may, on one hand, avoid an overly high pressure inside a valve cavity when the ball valve is welded to an indoor unit, thereby eliminating the potential safety hazard; and on the other hand, prevent air inside the indoor unit from flowing into the first connecting port to be mixed with the refrigerant inside an outdoor unit when a pressurized leak detection is performed, thereby ensuring the refrigerating performance. Furthermore, another technical problem to be solved by the present application is to provide a refrigerating system including the ball valve.

For those skilled in the art to better understand technical solutions of the present application, the present application is described in detail in conjunction with drawings and embodiments hereinafter.

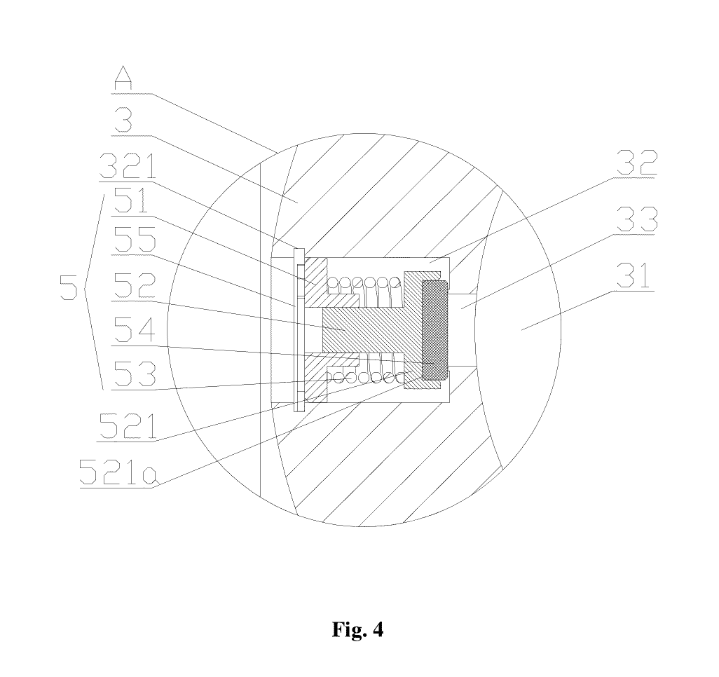

Reference is made to FIGS. 3 and 4, FIG. 3 is a schematic view showing the structure of the ball valve according to an embodiment of the present application, and FIG. 4 is a partially enlarged view of portion A of the ball valve in FIG. 3.

In one embodiment, as shown in FIG. 3, the ball valve according to the present application includes a valve body. The valve body has a valve cavity 11, a first connecting port 21 and a second connecting port 12. A valve ball 3 and a valve rod 4 are provided in the valve cavity 11, the valve ball 3 is provided with a valve ball passage 31, and the valve rod 4 may drive the valve ball 3 to rotate to allow or prevent the communication between the first connecting port 21 and the second connecting port 12 via the valve ball passage 31. The first connecting port 21 may be connected to an outdoor unit of a refrigerating system, and the second connecting port 12 may be connected to an indoor unit of the refrigerating system.

The valve body includes a valve main body 1 and a valve seat 2 which cooperate with each other to form the valve cavity 11, and the first connecting port 21 is arranged on the valve seat 2, and the second connecting port 12 is arranged on the valve main body 1. A first sealing member 61 for isolating the first connecting port 21 from the valve cavity 11 is provided between the valve seat 2 and one side of the valve ball 3, and a second sealing member 62 for isolating the second connecting port 12 from the valve cavity 11 is provided between the valve main body 1 and another side of the valve ball 3.

Based on the above structure, as shown in the FIG. 3, a one-way valve 5 having a preset opening pressure is provided between the valve ball passage 31 and the first connecting port 21. When the valve ball 3 disconnects the communication between the first connecting port 21 and the second connecting port 12, the one-way valve 5 allows a one-way communication from the valve ball passage 31 to the first connecting port 21. The one-way valve 5 may be provided on a spherical wall of the valve ball 3.

When the first connecting port 21 of the ball valve is connected to the outdoor unit and is filled with refrigerant, the valve ball 3 will be pushed out of the valve seat due to the pressure of the refrigerant, thus the first sealing member 61 is disengaged from the valve ball 3, and the refrigerant flows into the valve cavity 11 via a clearance between the first sealing member 61 and the valve ball 3, however, since the second sealing member 62 at this time is still in a sealing state at the side of the valve main body 1, the refrigerant cannot be discharged via this side of the valve main body, thus is remained inside the valve cavity 11. When the pressure inside the valve cavity 11 is balanced with the pressure inside a pipe at the side of the outdoor unit, the first sealing member 61 functions again, and the valve cavity 11 at this time is a sealed cavity. When the second connecting port 12 of the ball valve is welded to the indoor unit, since the valve cavity 11 has a constant volume, the pressure inside the valve cavity 11 increases as the temperature rises according to the expression of PV/T=constant. When a pressure difference between the pressure inside the valve cavity 11 and a pressure at the side of the first connecting port 21 reaches a preset opening pressure (for example, 5 MPa), the one-way valve 5 is opened to relieve the pressure of the valve cavity 11, and finally the pressure inside the valve cavity 11 and the pressure at the side of the first connecting port 21 are balanced, thereby eliminating the potential safety hazard.

When the side of the indoor unit is inflated to perform a pressurized leak detection, the valve ball 3 will be pushed out of the side of the valve main body 1, thus the second sealing member 62 at the side of the valve main body 1 is disengaged from the valve ball 3, and air inside the indoor unit flows into the valve cavity 11 via a clearance. Since the inflation pressure is generally small (for example, 4 MPa), which is smaller than the preset opening pressure, and the side of the outdoor unit is already filled with refrigerant at this time, a pressure difference between the valve cavity 11 and the side of the outdoor unit is definitely smaller than the preset opening pressure, thus the one-way valve 5 will not be opened, which also prevents the air inside the indoor unit from being mixed with the refrigerant inside the outdoor unit, thereby ensuring the refrigerating and heating performances of the system.

It is to be noted that, the preset opening pressure of the one-way valve 5 should be larger than a pressure difference between the inflation pressure inside the valve cavity 11 during the pressurized leak detection and the pressure at the side of the outdoor unit, that is, when the pressurized leak detection is performed, the one-way valve 5 cannot be opened. Furthermore, the preset opening pressure should not be too large as well, otherwise when the pressure inside the valve cavity 11 exceeds a safety value, the one-way valve 5 still cannot be opened, which may cause safety accidents.

It is to be noted that, a one-way valve 5 of any structure can achieve the purpose of the present application as long as it has the above preset opening pressure, and therefore is deemed to fall in the scope of the present application.

Furthermore, it is to be noted that, as an example in the present application, the valve body is of a separated structure having left and right portions, and includes the valve seat 2 and the valve main body 1, however the present application is not limited to this. Any valve body structure, such as a separated structure having upper and lower portions, is deemed to fall into the scope of the present application as long as components, for example the valve ball 3, the valve rod 4, and two sealing members, can be mounted therein.

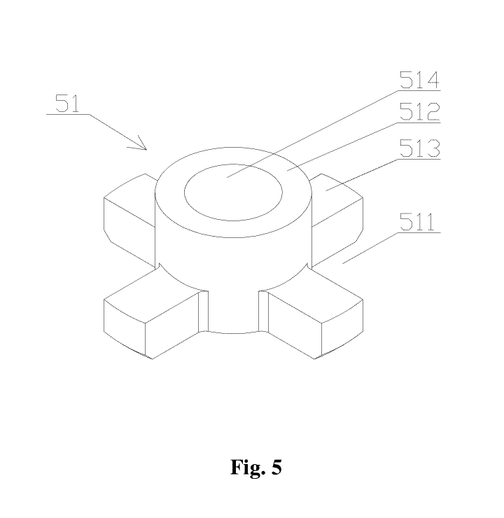

A one-way valve 5 of a particular structure is provided herein. For example, reference is made to FIGS. 4 and 5, FIG. 4 is a partially enlarged view of portion A of the ball valve in FIG. 3; and FIG. 5 is a schematic view showing the structure of a seat of the ball valve in FIGS. 3 and 4.

As shown in FIG. 4, the spherical wall of the valve ball 3 is provided with a mounting hole 32 for mounting the one-way valve 5, an inner side of the mounting hole 32 is provided with a valve port 33 in communication with the valve ball passage 31, and the valve port 33 may be opened or closed by the one-way valve 5. When a pressure difference between a pressure at the first connecting port 21 and a pressure in the valve ball passage 31 is larger than the preset opening pressure, the valve port 33 is opened by the one-way valve 5, and when the pressure difference at the two sides of the valve port 33 is smaller than the preset opening pressure, the valve port 33 is closed by the one-way valve 5.

As shown in FIG. 4, the one-way valve 5 includes a seat 51 provided inside the mounting hole 32, a guiding rod 52 movable with respect to the seat 51, a restoring component 53 provided between the seat 51 and the guiding rod 52, and a valve plug 54 connected to the guiding rod 52 for opening or closing the valve port 33. The seat 51 is provided with a seat passage 511 to communicate the mounting hole 32 with the first connecting port 21.

In the above structure, when the pressure difference at the two sides of the valve port 33 is larger than the preset opening pressure, the guiding rod 52 and the valve plug 54 move leftwards, and the restoring component 53 is compressed, that is, the guiding rod 52 moves in a direction close to the seat 51. At this time, the high-pressure refrigerant inside the valve cavity 11 may flow into the mounting hole 32 through the valve port 33.

In the above technical solution, the structure of the seat 51 may be designed. For example, as shown in FIG. 5, the seat 51 includes a seat main body 512 having an outer diameter smaller than an inner diameter of the mounting hole 32, and the seat main body 512 is provided with multiple supporting ribs 513 supported on an inner wall of the mounting hole 32 in a circumferential direction. In such structure, the seat 51 is supported inside the mounting hole 32 by the supporting ribs 513, and at the same time, the seat passage 511 for communicating the mounting hole 32 with the first connecting port 21 is formed by clearances between adjacent supporting ribs 513, and the refrigerant entering into the mounting hole 32 may flow toward the first connecting port 21 via the seat passage 511. Of course, as an alternative solution of the seat passage 511, an inclined hole may be directly provided in the spherical wall of the valve ball 3 to communicate the mounting hole 32 with the first connecting port 21. With such structural design, the seat 51 may have a simplified structure and a reduced manufacturing cost since the seat passage 511 is not required to be provided on the seat 51.

Further, as shown in FIG. 5, a guiding hole 514 is provided on the seat main body 512. As shown in FIG. 4, the guiding rod 52 has one end slidably provided in the guiding hole 514, and another end provided with a mounting portion 521 for mounting the valve plug 54. A restoring component 53 is arranged outside the circumferential outer portions of the seat main body 512 and the guiding rod 52, and is supported between the supporting ribs 513 and the mounting portion 521.

In the above structure, due to the cooperation between the guiding hole 514 and the guiding rod 52, the guiding rod 52 may move smoothly without waggling, which, in one aspect, ensures that the valve port 33 may be opened by the valve plug 54 stably, and in another aspect, ensures that the valve port 33 may be sealed by the valve plug 54 reliably. Furthermore, the space between the supporting ribs 513 and the mounting portion 521 is fully utilized to arrange the restoring component 53, thereby obtaining a more compact structure.

In the above technical solutions, the mounting structure of the valve plug 54 may be designed. For example, as shown in FIG. 4, the mounting portion 521 is provided with a mounting groove 521a, and the valve plug 54 is mounted in the mounting groove 521a in an interference fit or by riveting.

In the above technical solutions, the supporting structure of the seat 51 may be designed. For example, as shown in FIG. 4, the inner wall of the mounting hole 32 is provided with an annular groove 321 at a side close to the first connecting port 21, and the annular groove 321 is provided with a retaining ring 55 for supporting the seat 51.

Furthermore, a refrigerating system is provided according to the present application, which includes an indoor unit and an outdoor unit. The refrigerating system also includes the ball valve according to any one of the above solutions, the first connecting port 21 is connected to the outdoor unit, and the second connecting port 12 is connected to the indoor unit. The rest portions of the refrigerating system may refer to the conventional technology, which will not be described in detail herein.

A refrigerating system and a ball valve thereof according to the present application are described in detail hereinbefore. The principle and the embodiments of the present application are illustrated herein by specific examples. The above description of examples is only intended to help the understanding of the method and idea of the present application. It should be noted that, for the person skilled in the art, a few of modifications and improvements may be made to the present application without departing from the principle of the present application, and these modifications and improvements are also deemed to fall into the scope of the present application defined by the claims.

What is claimed is:

1. A ball valve, comprising a valve body, the valve body having a valve cavity, a first connecting port and a second connecting port; a valve rod and a valve ball being provided inside the valve cavity, the valve ball being provided with a valve ball passage, the valve rod being configured to drive the valve ball to rotate to allow or disconnect a communication between the first connecting port and the second connecting port via the valve ball passage; wherein,
a one-way valve having a preset opening pressure is provided between the valve ball passage and the first connecting port, and in a case that the valve ball disconnects the communication between the first connecting port and the second connecting port, the one-way valve is configured to allow a one-way communication from the valve ball passage to the first connecting port.

2. The ball valve according to claim 1, wherein the one-way valve is provided on a spherical wall of the valve ball.

3. The ball valve according to claim 2, wherein the spherical wall of the valve ball is provided with a mounting hole for mounting the one-way valve, an inner side of the mounting hole is provided with a valve port in communication with the valve ball passage, and the one-way valve is configured to open or close the valve port.

4. The ball valve according to claim 3, wherein the one-way valve comprises a seat provided inside the mounting hole, a guiding rod movable with respect to the seat, a restoring component provided between the seat and the guiding rod, and a valve plug connected to the guiding rod and configured to open or close the valve port.

5. The ball valve according to the claim 4, wherein the seat comprises a seat main body having an outer diameter smaller than an inner diameter of the mounting hole, the seat main body is provided with a plurality of supporting ribs supported on an inner wall of the mounting hole in a circumferential direction, and a seat passage configured to communicate the mounting hole with the first connecting port is formed by a clearance between adjacent supporting ribs.

6. The ball valve according to the claim 5, wherein the seat main body is provided with a guiding hole, and the guiding rod has one end slidably provided in the guiding hole and another end provided with a mounting portion for mounting the valve plug; and the restoring component is arranged outside circumferential outer portions of the seat main body and the guiding rod, and is supported between the supporting ribs and the mounting portion.

7. The ball valve according to the claim 6, wherein the mounting portion is provided with a mounting groove, and the valve plug is mounted in the mounting groove in an interference fit or by riveting.

8. The ball valve according to claim 4, wherein an inner wall of the mounting hole is provided with an annular groove at a side close to the first connecting port, and the annular groove is provided with a retaining ring for supporting the seat.

9. The ball valve according to claim 1, wherein the valve body comprises a valve main body and a valve seat, the valve seat and the valve main body cooperate with each other to form the valve cavity, the first connecting port is provided on the valve seat, and the second connecting port is provided on the valve main body; and
a first sealing member for isolating the first connecting port from the valve cavity is provided between the valve seat and one side of the valve ball, and a second sealing member for isolating the second connecting port from the valve cavity is provided between the valve main body and another side of the valve ball.

10. A refrigerating system, comprising an indoor unit and an outdoor unit; wherein the refrigerating system further comprises a ball valve comprising a valve body, the valve body has a valve cavity, a first connecting port and a second connecting port; a valve rod and a valve ball are provided inside the valve cavity, the valve ball is provided with a valve ball passage, the valve rod is configured to drive the valve ball to rotate to allow or disconnect a communication between the first connecting port and the second connecting port via the valve ball passage; wherein,
a one-way valve having a preset opening pressure is provided between the valve ball passage and the first connecting port, and in a case that the valve ball disconnects the communication between the first connecting port and the second connecting port, the one-way valve is configured to allow a one-way communication from the valve ball passage to the first connecting port; and
the first connecting port is connected to the outdoor unit, and the second connecting port is connected to the indoor unit.

11. The ball valve according to claim 2, wherein the valve body comprises a valve main body and a valve seat, the valve seat and the valve main body cooperate with each other to form the valve cavity, the first connecting port is provided on the valve seat, and the second connecting port is provided on the valve main body; and
a first sealing member for isolating the first connecting port from the valve cavity is provided between the valve seat and one side of the valve ball, and a second sealing member for isolating the second connecting port from the valve cavity is provided between the valve main body and another side of the valve ball.

12. The ball valve according to claim 3, wherein the valve body comprises a valve main body and a valve seat, the valve seat and the valve main body cooperate with each other to form the valve cavity, the first connecting port is provided on the valve seat, and the second connecting port is provided on the valve main body; and
a first sealing member for isolating the first connecting port from the valve cavity is provided between the valve seat and one side of the valve ball, and a second sealing member for isolating the second connecting port from the valve cavity is provided between the valve main body and another side of the valve ball.

13. The ball valve according to claim 4, wherein the valve body comprises a valve main body and a valve seat, the valve seat and the valve main body cooperate with each other to form the valve cavity, the first connecting port is provided on the valve seat, and the second connecting port is provided on the valve main body; and
a first sealing member for isolating the first connecting port from the valve cavity is provided between the valve seat and one side of the valve ball, and a second sealing member for isolating the second connecting port from the valve cavity is provided between the valve main body and another side of the valve ball.

14. The ball valve according to claim 5, wherein the valve body comprises a valve main body and a valve seat, the valve seat and the valve main body cooperate with each other to form the valve cavity, the first connecting port is provided on the valve seat, and the second connecting port is provided on the valve main body; and
a first sealing member for isolating the first connecting port from the valve cavity is provided between the valve seat and one side of the valve ball, and a second sealing member for isolating the second connecting port from the valve cavity is provided between the valve main body and another side of the valve ball.

15. The ball valve according to claim 6, wherein the valve body comprises a valve main body and a valve seat, the valve seat and the valve main body cooperate with each other to form the valve cavity, the first connecting port is provided on the valve seat, and the second connecting port is provided on the valve main body; and
a first sealing member for isolating the first connecting port from the valve cavity is provided between the valve seat and one side of the valve ball, and a second sealing member for isolating the second connecting port from the valve cavity is provided between the valve main body and another side of the valve ball.

16. The refrigerating system according to claim 10, wherein the one-way valve is provided on a spherical wall of the valve ball.

17. The refrigerating system according to claim 16, wherein the spherical wall of the valve ball is provided with a mounting hole for mounting the one-way valve, an inner side of the mounting hole is provided with a valve port in communication with the valve ball passage, and the one-way valve is configured to open or close the valve port.

18. The refrigerating system according to claim 17, wherein the one-way valve comprises a seat provided inside the mounting hole, a guiding rod movable with respect to the seat, a restoring component provided between the seat and the guiding rod, and a valve plug connected to the guiding rod and configured to open or close the valve port.

19. The refrigerating system according to claim 18, wherein the seat comprises a seat main body having an outer diameter smaller than an inner diameter of the mounting hole, the seat main body is provided with a plurality of supporting ribs supported on an inner wall of the mounting hole in a circumferential direction, and a seat passage configured to communicate the mounting hole with the first connecting port is formed by a clearance between adjacent supporting ribs.

20. The refrigerating system according to claim 10, wherein the valve body comprises a valve main body and a valve seat, the valve seat and the valve main body cooperate with each other to form the valve cavity, the first connecting port is provided on the valve seat, and the second connecting port is provided on the valve main body; and
a first sealing member for isolating the first connecting port from the valve cavity is provided between the valve seat and one side of the valve ball, and a second sealing member for isolating the second connecting port from the valve cavity is provided between the valve main body and another side of the valve ball.
